(19) United States
(12) Patent Application Publication
(10) Pub. No.: US 2026/0023611 A1
(43) Pub. Date: Jan. 22, 2026

(54) METHOD FOR DECOMPOSING AND DISTRIBUTING A MONOLITHIC APPLICATION

(71) Applicants: Robert Bosch GmbH, Stuttgart (DE); CARNEGIE MELLON UNIVERSITY, Pittsburgh, PA (US)

(72) Inventors: Anthony Rowe, Pittsburgh, PA (US); Behnaz Pourmohseni, Muenchen (DE); Fedor Smirnov, Erlangen (DE); Peter Schneider, Holzgerlingen (DE)

(21) Appl. No.: 19/263,704

(22) Filed: Jul. 9, 2025

(30) Foreign Application Priority Data
Jul. 22, 2024 (DE) 10 2024 206 860.8

(51) Int. Cl. G06F 9/50

(52) U.S. Cl. CPC G06F 9/5027

(57) ABSTRACT

A method for decomposing and distributing a monolithic application. The method includes: deploying the monolithic application on a data processing device; generating a behavior profile of the monolithic application based on an analysis of the monolithic application during a runtime thereof; determining at least one possible decomposition of the monolithic application into modules based on the generated behavior profile; initiating a deployment of the modules on a distributed system to provide a distributed application; initiating monitoring of a runtime behavior of the distributed application; initiating an optimization of the decomposition and of the deployment of the modules by maximizing a similarity between the monolithic application and the distributed application. A computer program, a device, and a storage medium are also described.

### FIELD

The present invention relates to a method for decomposing and distributing a monolithic application. The present invention further relates to a computer program, a device, and a storage medium for this purpose.

### BACKGROUND INFORMATION

In order to utilize distributed computing resources in distributed systems (e.g., to gain robustness and/or efficiency), application software must be modularized in order to match the capabilities of a distributed system (e.g., computing node resource constraints or constraints on communication between nodes).

Decomposing monolithic application software into a set of software modules usable in more modular, distributed software architectures (e.g., microservice-based architecture) is costly or practically impossible (e.g., due to the lack of thorough understanding of some parts of legacy software). During the decomposition of monolithic applications, each possible division of the application results in a certain set of software modules that can be deployed and executed separately on different resources. However, due to the cohesive nature of most monolithic applications, these modules generally have data dependencies on one another.

Finding a division that offers the best compromise between deployment flexibility and additional network traffic is already a difficult problem and is the focus of a large proportion of existing decomposition approaches, which are mostly based on statically analyzable code properties, such as coupling or cohesion or properties of software interfaces. More recent approaches to parallelization or decomposition of applications show that it is possible to automatically learn or optimize a favorable decomposition of programs given in LLVM IR (a bytecode-like intermediate representation) and to optimize the mapping of program components to the processor cores of a multi-core system. However, these approaches do not take into account real-time critical behavior of applications.

The following related techniques are described in the related art and scientific publications: Dividing code of monolithic applications into multiple smaller modules on the basis of static analysis of code and/or intermediate representations of code (e.g., bytecode) via existing analysis and decomposition techniques. Automatically decomposing application code on the basis of an intermediate representation (e.g., bytecode), followed by automated resource mapping of the resulting application code modules to the processing cores of a multi-core system for optimizing computing resource utilization and/or application performance. Orchestrating manually decomposed (e.g., “containerized”) application modules across multiple distributed (i.e., network-connected) computing resources.

### SUMMARY

According to aspects of the present invention, a method, a computer program, a data processing device, and a computer-readable storage medium are provided. Features and details of the present invention are disclosed herein. Features and details described in the context of the method according to the present invention in any case also correspond to the computer program according to the present invention, the data processing device according to the present invention, and the computer-readable storage medium according to the present invention, and vice versa.

According to one aspect of the present invention, a method for decomposing and distributing a monolithic application is provided. According to an example embodiment of the present invention, the method comprises the following steps, wherein the steps can be performed repeatedly and/or in a specific order. A monolithic application can refer to a software architecture in which all components and functionalities of the application are tightly integrated into a single cohesive unit. With this type of architecture, the entire application can be built, deployed, and scaled as a single entity.

In a first possible step, the monolithic application is deployed on a data processing device. The data processing device may be a server. In order to deploy the monolithic application on the data processing device, the following steps can be taken:
copying the monolithic application to the data processing device,
configuring the monolithic application to run on the data processing device by setting the appropriate environment variables and system settings,
starting the monolithic application and ensuring that it runs correctly on the data processing device.

In a next possible step, a behavior profile of the monolithic application is generated on the basis of an analysis of the monolithic application during a runtime thereof. The behavior profile of the monolithic application can further be improved on the basis of a static analysis of the monolithic application.

The behavior profile may represent a detailed description of how the application behaves in different scenarios and conditions. It may comprise information about functionality, features of the application, and interactions with users, an operating system of a host of the monolithic application and of other systems. The behavior profile may also comprise information about the performance, security, and reliability of the application. The static analysis may comprise an analysis of a bytecode of the monolithic application. Race conditions may also be determined if the monolithic application has multiple threads. Race conditions may refer to a situation where correct execution of a program depends on a timing or sequence of events that occur simultaneously. This may lead to unpredictable behavior or errors in the program.

In a next possible step, at least one possible decomposition of the monolithic application into modules is determined on the basis of the generated behavior profile. In other words, this step can be used to analyze how the monolithic application can be divided into different parts. These parts may comprise individual software functions or software modules or combinations of software functions or software modules.

In a next possible step, a deployment of the modules on a distributed system is initiated in order to provide a distributed application. In other words, the distributed application can represent the monolithic application in a distributed form, i.e., a functionality of the monolithic application is provided by at least two different modules of the distributed system. These two instances may run on a single data processing device or on multiple data processing devices, in particular on edge nodes.

In a next possible step, monitoring of a runtime behavior of the distributed application is initiated. In particular, the monitoring is carried out in a similar way to the analysis of the monolithic application during a runtime thereof and, where appropriate, also to the static analysis of the monolithic application, i.e., the same parameters and properties can be determined in order to allow a comparison of the distributed application with the monolithic application.

In a next possible step, an optimization of the decomposition and of the deployment of the modules is initiated by maximizing a similarity between the monolithic application and the distributed application. This may include comparing a behavior profile of the distributed application with the behavior profile of the monolithic application, either by running them in parallel or by comparing the behavior profile of the distributed application with the previously generated behavior profile of the monolithic application. This step may comprise iteratively adapting the deployment both by generating alternative module decompositions and by changing a placement of the resulting modules in the distributed system.

The method according to the present invention can provide an innovative approach to address the problems of optimizing deployment on edge nodes. By actively including the monolithic application in the optimization process, the method can optimize the distributed deployment thereof in order to maximize similarity between the behaviors of the monolithic and of the distributed application. This dynamic decomposition or distribution scheme can make adaptability to dynamically changing deployment conditions possible, such as varying edge node resources or networking capabilities, thereby allowing more efficient and more effective deployment of the application.

Advantages of the method according to the present invention may comprise the following: Reuse of existing real-time critical monolithic applications can be made possible in distributed systems without any manual refactoring work. Distributed deployments can be made possible for currently centralized monolithic applications (or some of them) in order to improve efficient utilization of distributed resources. Resource-efficient use of redundancy or replication can be made possible for only the parts of a (monolithic) application that have high availability or (security) integrity requirements. An application decomposition mechanism can be implemented for applications written in any language that can be compiled into a virtualized bytecode representation (e.g., WASM), in contrast to language-specific mechanisms. A mechanism for decomposing applications can be provided that does not require any access to the application source code files (e.g., C/C++/Rust/ . . . files), but may only require access to the compiled virtualized bytecode representation. This can help protect the confidentiality of implemented business logic if necessary. By means of a detailed runtime comparison with the behavior profile of the monolithic application, in particular in terms of transition states and timing behavior, automated self-verification of the selected decomposition can be made possible.

According to an example embodiment of the present invention, it is possible that the deployment of the monolithic application is carried out in a bytecode representation of the monolithic application. In particular, a bytecode representation is a low-level, machine-readable code that can be generated from a higher-level programming language. It can be a set of instructions that can be executed by a virtual machine or an interpreter, and is in particular designed to be platform-independent. The bytecode representation can be used to improve the performance and portability of applications. It is possible that the deployment of the monolithic application is carried out in a virtualized bytecode representation, such as WASM. This approach can make programming-language-independent generation of a detailed behavior profile of the monolithic application possible, which can then be used to determine promising divisions into modules. This may further allow utilizing analyzabilities of the virtualized bytecode representation (e.g., WASM) to determine promising divisions into modules and to estimate an execution time of these modules on available edge resources of the distributed system.

According to an example embodiment of the present invention, it is also possible that generating the behavior profile comprises the following step:
monitoring an internal state as well as inputs and outputs of the monolithic application, wherein the inputs and outputs are monitored with respect to particular values and timing behavior.

Monitoring the internal state, inputs, and outputs of the monolithic application can advantageously provide extensive insights for generating the detailed behavior profile. The inputs may result from a detection of at least one sensor of the data processing device, and the outputs may be control signals for at least one actuator of the data processing device. It is also possible that the inputs and/or outputs result, at least in part, from at least one other application or data source, such as a database, that is in communication with the monolithic application.

According to an example embodiment of the present invention, it is possible that determining the at least one possible decomposition comprises the following step:
instrumenting and analyzing the bytecode representation of the monolithic application.

Instrumenting may comprise injecting delays between program parts of the bytecode representation. Analyzing may comprise identifying patterns or components of the monolithic application that cannot be divided without causing an error or undesirable behavior of the monolithic application. This step may advantageously allow the generation of a detailed behavior profile of the monolithic application, thereby making it possible for the method to accurately identify reasonable divisions into modules.

According to an example embodiment of the present invention, it is also possible that determining the at least one possible decomposition further comprises the following step:
filtering out decompositions that compromise at least one real-time and/or internal state consistency requirement.

This step can advantageously allow eliminating potential module divisions that may lead to inconsistencies or interruptions in the performance of the distributed application. This step may be based on a result of instrumenting and analyzing the bytecode representation, wherein it is possible to determine the decompositions that compromise the at least one real-time and/or internal state consistency requirement. The real-time and/or internal state consistency requirement may refer to a need for the application to maintain a consistent and up-to-date internal state in real time, i.e., without any delay or latency. This may be important for ensuring that the application functions correctly and that any data or information it processes are accurate and reliable. In other words, the application may need to be able to handle and process data in real time while maintaining a consistent internal state in order to ensure that output is correct and reliable.

According to an example embodiment of the present invention, it is also possible that initiating the deployment of the modules on the distributed system is carried out taking into account at least one resource property of the distributed system. The at least one resource property may be a computing power, storage capacity, and/or network bandwidth of at least one data processing device of the distributed system, in particular of at least one edge node of the distributed system. This can be carried out in order to advantageously ensure optimal allocation and execution of the modules. This can allow more efficient utilization of resources and better overall performance of the distributed application.

According to an example embodiment of the present invention, it is possible that initiating the optimization is carried out iteratively and/or taking into account the generated behavior profile of the monolithic application. This can advantageously allow more precise adjustment of the decomposition and deployment of the modules. Taking the generated behavior profile of the monolithic application into account can be carried out in order to achieve a required or defined degree of similarity between the distributed and the monolithic application.

In another aspect of the present invention a computer program can be provided, in particular a computer program product, comprising instructions that, when the computer program is executed by a computer, cause the computer to carry out the method according to the present invention. The computer program according to the present invention can thus have the same advantages as described in detail with reference to a method according to the present invention.

In another aspect of the present invention, a data processing device can be provided which is designed to perform the method according to the present invention. A computer that executes the computer program according to the present invention may be provided as the device, for example. The computer can comprise at least one processor that can be used to execute the computer program. Additionally, a non-volatile data memory may be provided, in which the computer program can be stored and from which the computer program can be read by the processor for execution.

According to another aspect of the present invention, a computer-readable storage medium may be provided that comprises the computer program according to the present invention and/or instructions that, when executed by a computer, cause the computer to perform the steps of the method according to the present invention. The storage medium may be formed as a data storage device, such as a hard disk and/or a non-volatile memory and/or a memory card and/or a solid-state drive. The storage medium may be integrated into the computer, for example.

Furthermore, the method according to the present invention may be implemented as a computer-implemented method. Alternatively or additionally, at least one of the disclosed method steps of the present invention may be computer-implemented and/or automated.

Further advantages, features, and details of the present invention are apparent from the following description, in which example embodiments of the present invention are described in detail with reference to the figures. In this context, the features mentioned herein may be essential to the present invention individually or in any combination.

### BRIEF DESCRIPTION OF THE DRAWINGS

FIG. 1 shows a method, a computer program, a storage medium, and a device according to example embodiments of the present invention.

FIG. 2 shows an exemplary monolithic application architecture according to example embodiments of the present invention.

FIG. 3 shows an exemplary distributed application architecture according to example embodiments of the present invention.

### DETAILED DESCRIPTION OF EXAMPLE EMBODIMENTS

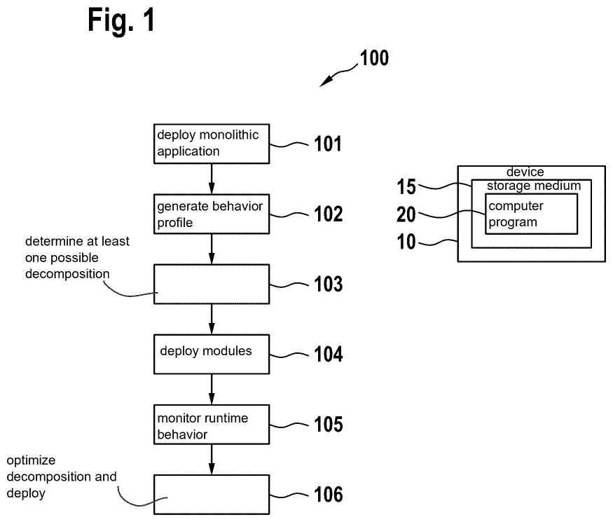

FIG. 1 shows a method 100, computer program 20, a storage medium 15, and a device 10 according to embodiments of the present invention.

In particular, FIG. 1 shows an embodiment of a method 100 for decomposing and distributing a monolithic application. In a first step 101, the monolithic application is deployed on a data processing device 1. In a second step 102, a behavior profile of the monolithic application is generated on the basis of an analysis of the monolithic application during a runtime thereof. The behavior profile of the monolithic application can further be improved on the basis of a static analysis of the monolithic application. In a third step 103, at least one possible decomposition of the monolithic application into modules 2 is determined on the basis of the generated behavior profile. In a fourth step 104, a deployment of the modules 2 on a distributed system 3 is initiated in order to provide a distributed application. In a fifth step 105, monitoring of a runtime behavior of the distributed application is initiated. In a sixth step 106, an optimization of the decomposition and of the deployment of the modules 2 is initiated by maximizing a similarity between the monolithic application and the distributed application.

The present invention according to embodiments focuses on decomposing and/or distributing real-time and security-critical applications in cyber-physical systems, which is an even more difficult problem, in particular due to their timing and state sensitivity.

Deploying the decomposed modules separately may mean that (a) communication between the modules may take significantly longer, and (b) the application may be vulnerable to inconsistent, potentially unsafe states, which may result from race conditions between the individual states of the modules. This situation cannot occur during a monolithic execution, in which the entire application operates on a shared atomic state. These two aspects may be difficult to integrate into a formal static analysis.

A modularization solution that fits one specific type or instance of a distributed system may not fit other types or instances due to different system capabilities, e.g., regarding available nodes and/or resources and/or communication links.

For real-time critical applications, dynamic aspects such as runtime resource usage and timing of functional behavior may also need to be taken into account in order to achieve the same or an even better level of reliability compared to a monolithic implementation. This can in particular become problematic if the available computing and networking resources are dynamically shared between multiple independent applications.

The method according to embodiments of the present invention relates to an automated technique for dynamically decomposing monolithic code into modules that can be deployed on heterogeneous distributed resources while preserving real-time and behavioral requirements of the monolithic code.

The method according to embodiments of the present invention describes a runtime-behavior-observation-based technique for automatically modularizing or dividing a monolithic application software for distributed deployment on multiple connected edge computing nodes.

The method according to embodiments of the present invention is based in particular on compiling monolithic application software into a virtualized bytecode representation, e.g., the WASM (WebAssembly) format, and using bytecode-virtualization-based runtime analyzabilities to perform the following steps:

In a first step, a model of the control flows, data flows, and runtime properties of different bytecode sections can be generated on the basis of an observation of the runtime behavior of the monolithic application. In this step, runtime analysis mechanisms of the virtualized bytecode representation (e.g., WASM) can be used to analyze and estimate a runtime of different dividing options, while various instrumentations of the monolithic application can be used to check whether certain divisions lead to timing violations (e.g., missed deadlines or early/late I/O operations) or an inconsistent/unsafe application state.

In a second step, information resulting from the first step can be used to automatically divide the monolithic application into multiple modules, which can then be deployed on the distributed system. The constraints of the distributed target system (e.g., number and type of resources of the edge computing nodes, network resources . . . ) can be taken into account for both the division decisions and the deployment decisions.

In a third step, selected dividing points and the deployment of the resulting modules can be iteratively refined in an optimization loop that maximizes the runtime behavior similarity (in particular with regard to input and output, or I/O, timing and intended functional behavior) between the parallel-executed unmodified monolithic application and the distributed application modules.

Advantages of the present invention according to embodiments may include the following: Reuse of existing real-time critical monolithic applications can be made possible in distributed systems without any manual refactoring work. Distributed deployments can be made possible for currently centralized monolithic applications (or some of them) in order to improve efficient utilization of distributed resources. Resource-efficient use of redundancy or replication can be made possible for only the parts of a (monolithic) application that have high availability or (security) integrity requirements. An application decomposition mechanism can be implemented for applications written in any language that can be compiled into a virtualized bytecode representation (e.g., WASM), in contrast to language-specific solutions. A mechanism for decomposing monolithic applications can be provided that does not require any access to the application source code files (e.g., C/C++/Rust/ . . . files), but may only require access to the compiled virtualized bytecode representation. This can help protect the confidentiality of implemented business logic if necessary. By means of a detailed runtime comparison with the behavior profile of the monolithic application, in particular in terms of transition states and timing behavior, automated self-verification of the selected decomposition can be made possible.

Compared to static approaches, the dynamic decomposition or distribution scheme according to embodiments of the present invention may provide the advantage of greater adaptability to dynamically changing deployment conditions, such as varying quantity and types of edge computing nodes, networking capabilities, or edge-computing-node-specific (dynamically varying) resource constraints.

The method according to an embodiment of the present invention addresses the aforementioned problems by actively including the monolithic application in an optimization process that iteratively optimizes its distributed deployment both with regard to application division and with regard to distributed deployment of the resulting application parts.

The method according to embodiments of the present invention may comprise the following steps:
In a first step, the monolithic application can be deployed in a non-distributed manner in a virtualized bytecode representation (e.g., WASM). In a second step, an internal state and I/O signals (with respect to values and timing) of the monolithic application can be observed and recorded in a detailed behavior profile. In a third step, analyzabilities of the virtualized bytecode representation (e.g., WASM) can be used to determine promising divisions into modules and to estimate an execution time of these modules on available edge resources of the distributed system. In a fourth step, instrumentation mechanisms of the virtualized bytecode (e.g., WASM) can be used to filter out module divisions that would compromise the real-time or state consistency requirements of the application. In a fifth step, the application can be deployed in a distributed manner on a distributed (e.g., edge computing) system. In a sixth step, a runtime behavior of the modules of the application in the distributed deployment can be observed, in particular with regard to an internal state, I/O signals, timing, and functional behavior. In a seventh step, a joint iterative optimization of the application decomposition and of the deployment of the resulting modules can be carried out, wherein a similarity between the behaviors of the monolithic and of the distributed deployment (and other objectives, e.g., availability or resource utilization) are maximized.

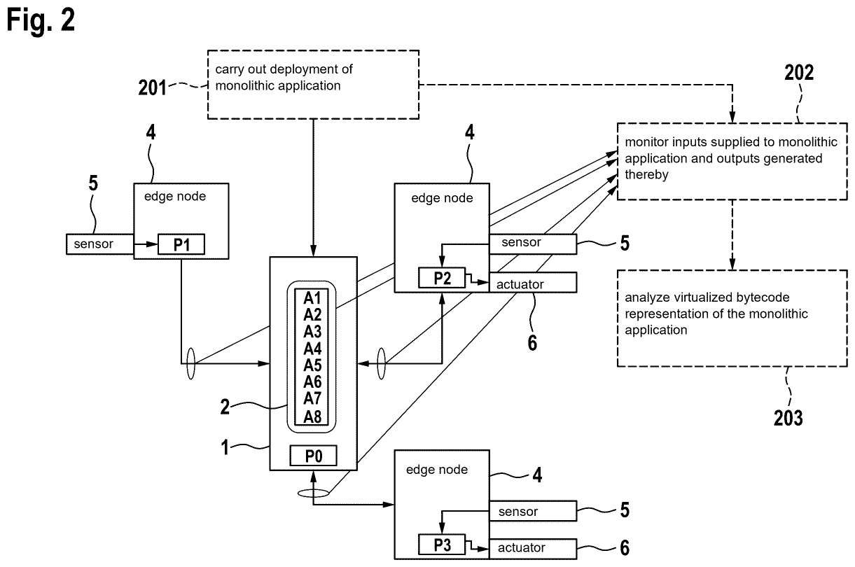

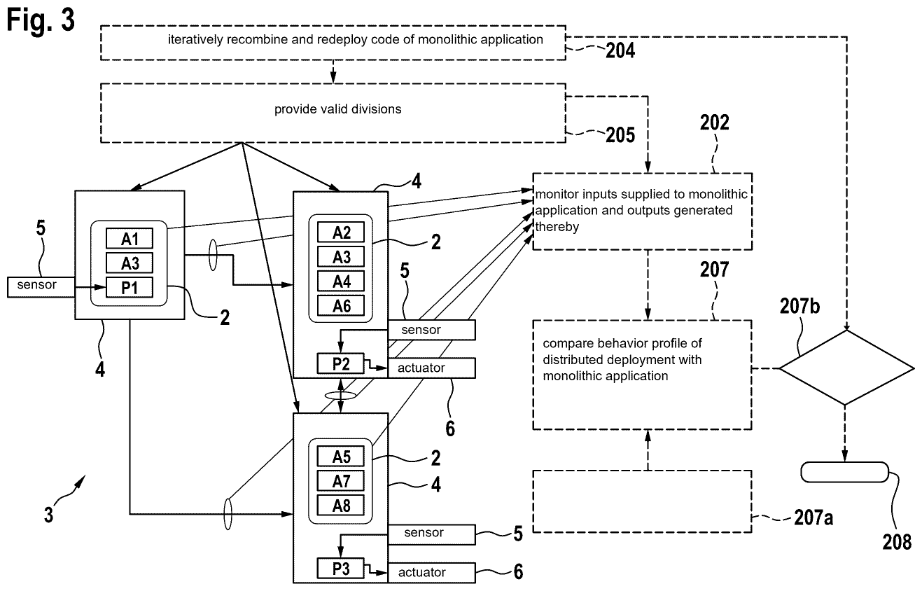

An exemplary implementation of each of the steps in the above paragraph is described below with reference to FIGS. 2 and 3:
According to the first step 201, a deployment of the monolithic application (compiled into a virtualized bytecode representation (e.g., WASM)) is carried out on a data processing device 1, which is a server in this embodiment, and can execute the intended functionality thereof there. Thus, all modules 2, i.e., modules A1 to A8, can be deployed on the server. Only individual platform software P1 to P3 can be deployed on the edge nodes 4. According to the second step 202, inputs supplied to the monolithic application and outputs generated thereby can then be monitored both with regard to the values thereof and with regard to the relative timing thereof. The inputs may, for example, comprise sensor data from at least one sensor 5. The outputs may, for example, comprise actuator signals designed for at least one actuator 6. The goal of this step may be to obtain a profile of the behavior of the monolithic application, either through continuous monitoring or by learning a relationship between the input signals and the output signals. According to the third step 203, which can also be performed offline, the virtualized bytecode representation of the monolithic application can be analyzed in order to identify reasonable ways of dividing it into modules 2 and to use the deterministic semantics of the bytecode representation (e.g., WASM) to estimate the runtime of these modules 2 on edge nodes 4 of a distributed system 3 where the application is to be deployed. Wait functions related to physical I/O time synchronization can be identified in the monolithic application and removed (e.g., by observing specific system calls or access to the external state of other applications). According to the fourth step 204, a code of the monolithic application can be iteratively recompiled and redeployed. Each iteration can correspond to a possible division of the monolithic application. During each iteration, the bytecode of the monolithic application can be supplemented with instrumentation, which can introduce delays between program parts of the monolithic application that would be part of different modules 2 in the division being analyzed. By running this instrumented version of the monolithic application, a search space of possible divisions can be pruned by removing divisions that lead to inconsistent states and/or security violations and by annotating valid divisions with a maximum time that can elapse between the execution thereof without violating the timing constraints of the overall application. According to the fifth step 205, a set of valid divisions of the fourth step 204 can be provided to an optimizer or orchestrator (not shown), which can use the information about the expected runtime of the third step 203 of the modules 2 and the timing constraints for the communication between modules 2 of the fourth step 204. This can be carried out in order to (a) select a division and find a promising deployment of the modules 2 thereof on the available edge resources, (b) automatically generate the modules 2 by dividing the monolithic application, and (c) deploy the modules 2 on the distributed resources. According to the sixth step 206, during a runtime of the distributed application, the application can be continuously monitored, in particular similarly to the monitoring of the monolithic application in the second step 202. According to the seventh step 207, the behavior profile of the distributed deployment can then be compared with that of the monolithic application, either by running them in parallel or by comparing it with the behavior model learned in the second step 202. An optimizer or orchestrator can be used for this purpose, which iteratively adjusts the deployment by both generating alternative module divisions and changing the placement of the resulting modules 2 of the application. This can be carried out in order to (a) maximize a similarity between the observed behavior of the distributed application and the behavior profile of the monolithic application, and (b) optimize secondary objectives, such as resource utilization. If the similarity criteria have not yet been met, the method can be repeated iteratively from the fourth step 204 onward.

The above description of the embodiments describes the present invention in the context of examples. Of course, individual features of the embodiments can be freely combined with one another as long as this is technically reasonable, without departing from the scope of the present invention.

1-10. (canceled)

11. A method for decomposing and distributing a monolithic application, comprising the following steps:
deploying the monolithic application on a data processing device;
generating a behavior profile of the monolithic application based on an analysis of the monolithic application during a runtime of the monolithic application;
determining at least one possible decomposition of the monolithic application into modules based on the generated behavior profile;
initiating a deployment of the modules on a distributed system to provide a distributed application;
initiating monitoring of a runtime behavior of the distributed application; and
initiating an optimization of the decomposition and of the deployment of the modules by maximizing a similarity between the monolithic application and the distributed application.

12. The method according to claim 11, wherein the deploying the monolithic application is carried out in a bytecode representation of the monolithic application.

13. The method according to claim 11, wherein the generating of the behavior profile includes the following step:
monitoring an internal state, inputs, and outputs of the monolithic application, wherein the inputs and outputs are monitored with respect to particular values and timing behavior.

14. The method according to claim 12, wherein the determining the at least one possible decomposition includes the following step:
instrumenting and analyzing the bytecode representation of the monolithic application.

15. The method according to claim 11, wherein the determining of the at least one possible decomposition further includes the following step:
filtering out decompositions that compromise at least one real-time and/or internal state consistency requirement.

16. The method according to claim 11, wherein the initiating of the deployment of the modules on the distributed system is carried out taking into account at least one resource that is characteristic of the distributed system.

17. The method according to claim 11, wherein the initiating of the optimization is carried out iteratively and/or taking into account the generated behavior profile of the monolithic application.

18. A data processing device, the data processing device configured to decompose and distribute a monolithic application, comprising the following steps:
deploying the monolithic application on a data processing device;
generating a behavior profile of the monolithic application based on an analysis of the monolithic application during a runtime of the monolithic application;
determining at least one possible decomposition of the monolithic application into modules based on the generated behavior profile;
initiating a deployment of the modules on a distributed system to provide a distributed application;
initiating monitoring of a runtime behavior of the distributed application; and
initiating an optimization of the decomposition and of the deployment of the modules by maximizing a similarity between the monolithic application and the distributed application.

19. A non-transitory computer-readable storage medium on which are stored instructions for decomposing and distributing a monolithic application, the instructions, when executed by a computer, causing the computer to perform the following steps:
deploying the monolithic application on a data processing device;
generating a behavior profile of the monolithic application based on an analysis of the monolithic application during a runtime of the monolithic application;
determining at least one possible decomposition of the monolithic application into modules based on the generated behavior profile;
initiating a deployment of the modules on a distributed system to provide a distributed application;
initiating monitoring of a runtime behavior of the distributed application; and
initiating an optimization of the decomposition and of the deployment of the modules by maximizing a similarity between the monolithic application and the distributed application.
